(19) United States
(12) Patent Application Publication
(10) Pub. No.: US 2026/0162872 A1
(43) Pub. Date: Jun. 11, 2026

(54) COIL COMPONENT AND METHOD OF MANUFACTURING COIL COMPONENT

(71) Applicant: TAIYO YUDEN CO., LTD., Tokyo (JP)

(72) Inventors: Kozue IMAIZUMI, Tokyo (JP); Kenichiro NOGI, Tokyo (JP)

(21) Appl. No.: 19/415,266

(22) Filed: Dec. 10, 2025

(30) Foreign Application Priority Data
Dec. 11, 2024 (JP) 2024-217091

(51) Int. Cl. H01F 27/245; H01F 27/02; H01F 27/28; H01F 27/29; H01F 41/02

(52) U.S. Cl. CPC H01F 27/245; H01F 27/022; H01F 27/292; H01F 41/0233; H01F 2027/2809

(57) ABSTRACT

A coil component according to one aspect of the disclosure includes a magnetic base body containing a plurality of metal magnetic particles, and a coil conductor provided in the magnetic base body, the coil conductor extending around a coil axis. The coil conductor is composed mainly of a metal element M. The coil conductor has a first coil conductor pattern and a second coil conductor pattern. The magnetic base body has a first interposed layer having a first surface and a second surface, the first surface intersecting the coil axis, the second surface facing the first surface in a coil axis direction that extends along the coil axis. The first interposed layer contains a plurality of segregates composed mainly of the metal element M. The first and second coil conductor patterns are connected by means of a first via conductor.

### CROSS-REFERENCE TO RELATED APPLICATIONS

This application is based on and claims the benefit of priority from Japanese Patent Application Serial No. 2024-217091 (filed on Dec. 11, 2024), the contents of which are hereby incorporated by reference in their entirety.

### TECHNICAL FIELD

The present disclosure relates mainly to a coil component and a method of manufacturing the coil component.

### BACKGROUND

Coil components are passive elements used in electronic devices. For example, coil components are used to eliminate noise in power source lines or signal lines. A coil component includes a magnetic base body made of a magnetic material, a coil conductor provided in the magnetic base body with the end surfaces of the coil conductor being externally exposed, a first external electrode connected to one end of the coil conductor, and a second external electrode connected to the other end of the coil conductor.

During use of the coil component, the coil conductor may experience significant current flow. For example, when the coil component is employed in power source circuits and DC/DC converter circuits, it is assumed that the coil conductor will experience a large current during use of the coil component. For the coil component that is subject to a large current, suppression of magnetic saturation in the magnetic base body is an important issue. In order to prevent magnetic saturation in the magnetic base body, the magnetic base body contains metal magnetic particles composed mainly of a soft magnetic metal material. The soft magnetic metal material has a higher saturation magnetic flux density than a ferrite material. Therefore, the magnetic base body containing the metal magnetic particles is less likely to cause magnetic saturation than a magnetic base body made of a ferrite material.

For the coil component that is subject to a large current, a reduction in the DC resistance (Rdc) of the coil conductor is also required. In order to provide a coil conductor with a reduced DC resistance, it is known to connect two coil conductor patterns of the same shape in parallel. The two coil conductor patterns connected in parallel increase the cross-sectional area of the current path, thus reducing the DC resistance of the coil conductor. In such a coil component including the two coil conductor patterns, a thin magnetic layer that forms part of the magnetic base body is interposed between the two coil conductor patterns. The two coil conductor patterns are electrically connected to each other by means of via conductors that penetrate the magnetic layer. A conventional coil component including two coil conductor patterns connected in parallel is disclosed in Japanese Patent Application Publication No. 2011-187535.

The coil conductor patterns are composed of a highly conductive metal such as Ag or Cu, while the magnetic base body is composed of a soft magnetic metal material that is composed principally of Fe or Ni. Since the magnetic base body and the coil conductor patterns are made of different materials from each other, the linear expansion coefficient of the magnetic layer, which is interposed between the coil conductor patterns, is different from that of the coil conductor patterns. For this reason, when the coil component reaches a high temperature, the magnetic layer shrinks at a different shrinkage rate than the coil conductor patterns, causing thermal distortion in the magnetic layer.

Since the coil component is required to be compact, the magnetic layer interposed between the coil conductor patterns is thin. For example, the magnetic layer interposed between the coil conductor patterns has a thickness of several to 10 μm, approximately. Therefore, the magnetic layer interposed between the coil conductor patterns has a lower strength than the other areas of the magnetic base body.

Because of the above circumstances, the coil component having as the coil conductor two coil conductor patterns connected in parallel may possibly experience cracks in the magnetic layer due to thermal distortion. In addition, the thermal distortion may cause the magnetic layer to peel off from the coil conductor patterns.

### SUMMARY

It is an object of the present disclosure to solve or alleviate at least part of the drawbacks mentioned above. One of the specific purposes of the present disclosure is to provide a coil component including a coil conductor made up by two coil conductor patterns connected in parallel, where cracks are prevented in a magnetic layer interposed between the coil conductor patterns. Another one of the specific purposes of the present disclosure is to provide a coil component including a coil conductor made up by two coil conductor patterns connected in parallel, where a magnetic layer interposed between the coil conductor patterns is prevented from peeling off from the coil conductor patterns. The various inventions disclosed herein may be collectively referred to as “the invention”.

Other objects of the disclosure will be made apparent through the entire description in the specification. The inventions recited in the claims may also address any other drawbacks in addition to the above drawback.

An aspect of the disclosure provides a coil component including: a magnetic base body containing a plurality of metal magnetic particles; a coil conductor provided in the magnetic base body so as to extend around a coil axis; a first external electrode electrically connected to one end of the coil conductor; and a second external electrode electrically connected to another end of the coil conductor. The coil conductor is composed mainly of a metal element M. In one aspect, the coil conductor has a first coil conductor pattern and a second coil conductor pattern. The magnetic base body has a first interposed layer having a first surface and a second surface, the first surface intersecting the coil axis, the second surface facing the first surface in a coil axis direction that extends along the coil axis. The first interposed layer contains a plurality of segregates composed mainly of the metal element M. The first coil conductor pattern touches the first surface of the first interposed layer, and the second coil conductor pattern touches the second surface of the first interposed layer. When viewed in the coil axis direction, the first coil conductor pattern has a same shape as the second coil conductor pattern. The first and second coil conductor patterns are connected by means of a first via conductor.

### ADVANTAGEOUS EFFECTS

An aspect of the disclosure provides a coil component including a coil conductor made up by two coil conductor patterns connected in parallel, where cracks are prevented in a magnetic layer interposed between the coil conductor patterns.

### BRIEF DESCRIPTION OF THE DRAWINGS

FIG. 1 is a schematic perspective view showing a coil component including a magnetic base body according to one embodiment of the present invention.

FIG. 2 is an exploded perspective view of the coil component shown in FIG. 1.

FIG. 3 is a sectional view schematically showing a section of the coil component of FIG. 1 along the line I-I.

FIG. 4 is an enlarged sectional view schematically showing a region A of a base body.

FIG. 5 is an enlarged sectional view schematically showing a region B of the base body.

FIG. 6 is a flow chart showing a process of manufacturing a coil component according to one embodiment of the present invention.

### DESCRIPTION OF THE PREFERRED EMBODIMENTS

Various embodiments of the disclosure will be described hereinafter with reference to the appended drawings. Throughout the drawings, the same components are denoted by the same reference numerals. For convenience of explanation, the drawings are not necessarily drawn to scale. The following embodiments of the present disclosure do not limit the scope of the claims. The elements included in the following embodiments are not necessarily essential to solve the problem addressed by the invention.

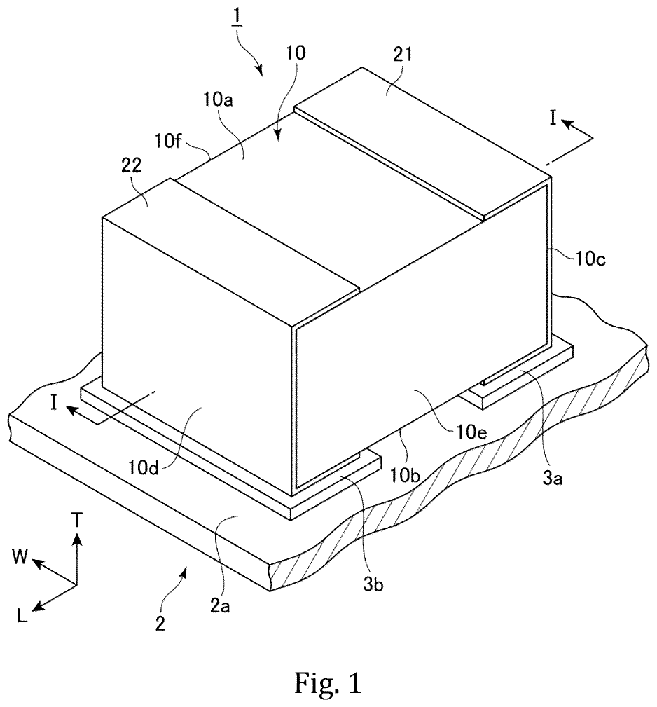

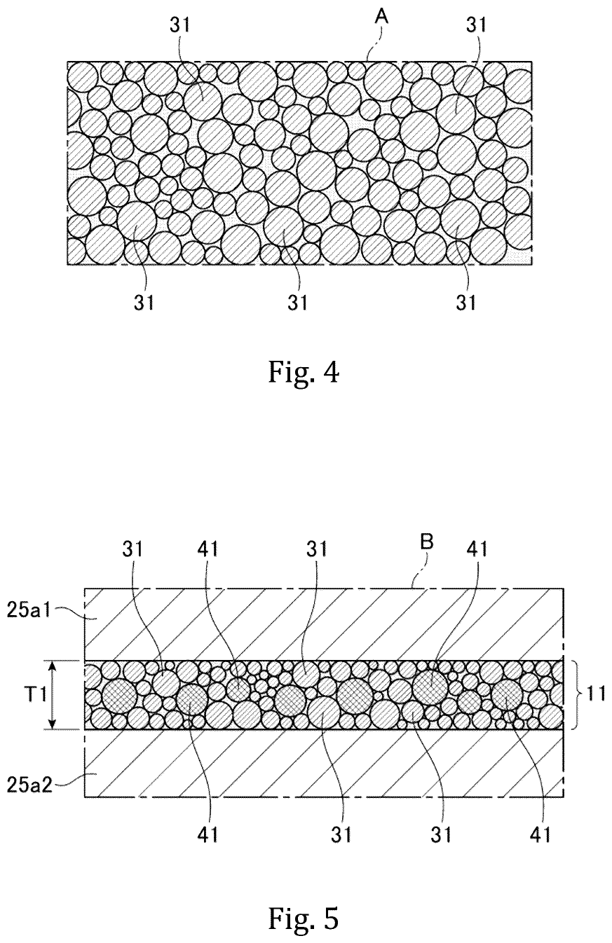

The following first briefly describes a coil component 1 relating to an embodiment with reference to FIGS. 1 to 3, and then describes the microstructure of the coil component 1 with reference to FIGS. 4 and 5.

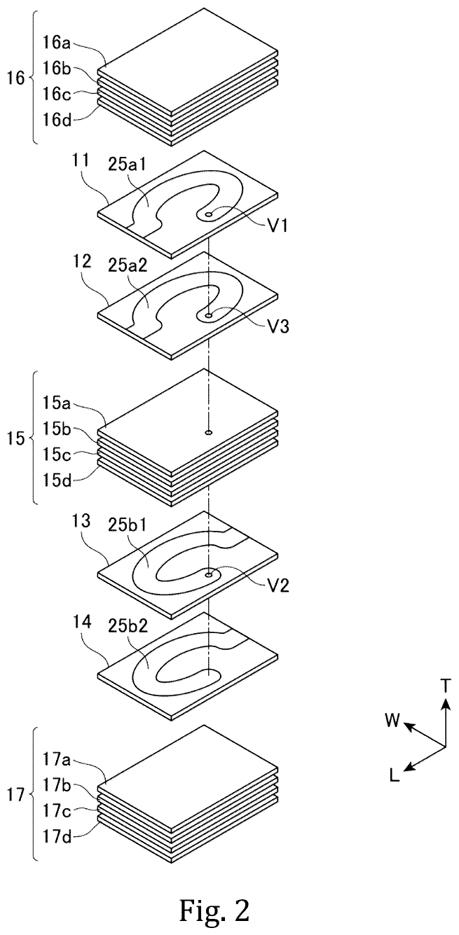

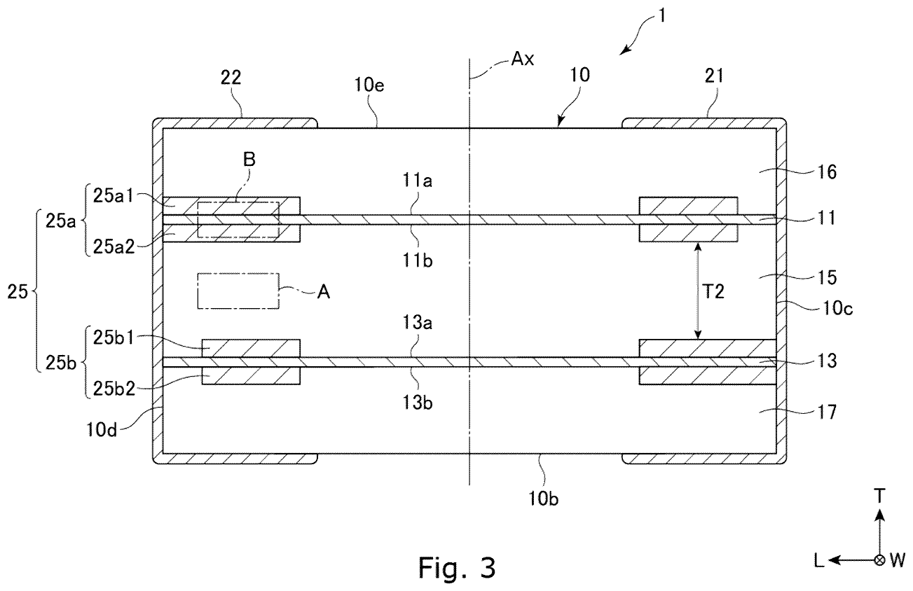

FIG. 1 is a schematic perspective view of the coil component 1, and FIG. 2 is an exploded perspective view of the coil component 1. FIG. 3 is a schematic sectional view of the coil component 1 along the line I-I of FIG. 1. In FIG. 2, no external electrodes are shown for convenience of description.

By way of one example of the coil component 1, FIGS. 1 to 3 show a laminated inductor. The laminated inductor shown is an example of the coil component 1 to which the disclosure can be applied. The disclosure can also be applied to various types of coil components other than the laminated inductor. For example, the present disclosure can be applied to wire-wound coil components or planar coils.

As shown, the coil component 1 includes a base body 10, a coil conductor 25 provided in the base body 10, an external electrode 21 disposed on a surface of the base body 10, and an external electrode 22 disposed on the surface of the base body 10 at a position away from the external electrode 21. The base body 10 is a magnetic base body made of a magnetic material. The base body 10 is an example of the feature “magnetic base body” recited in the claims. The base body 10 may be referred to as the magnetic base body 10 in this specification. As will be described below, the base body 10 contains a large number of metal magnetic particles.

As shown in FIG. 3, the coil conductor 25 includes a first circling portion 25a and a second circling portion 25b. As will be described below, the first and second circling portions 25a and 25b are electrically connected by means of a via conductor V3.

The coil component 1 may be mounted on a mounting substrate 2a. In the illustrated embodiment, the mounting substrate 2a has lands 3a and 3b provided thereon. The coil component 1 is mounted on the mounting substrate 2a by bonding the first external electrode 21 to the land 3a and bonding the second external electrode 22 to the land 3b. A circuit board 2 according to one embodiment of the present disclosure includes the coil component 1 and the mounting substrate 2a having the coil component 1 mounted thereon. The circuit board 2 can be installed in various electronic devices. The electronic devices in which the circuit board 2 can be installed include smartphones, tablets, game consoles, electrical components of automobiles, servers, and various other electronic devices.

The coil component 1 may be an inductor, a transformer, a filter, a reactor, an inductor array and any one of various other coil components. The coil component 1 may alternatively be a coupled inductor, a choke coil, and any one of various other magnetically coupled coil components. Applications of the coil component 1 are not limited to those explicitly described herein.

In one embodiment of the present disclosure, the base body 10 is configured such that the dimension in the L-axis direction (length dimension) is greater than the dimension in the W-axis direction (width dimension) and the dimension in the T-axis direction (height dimension). For example, the coil component 1 has a length dimension of 1.0 mm to 6.0 mm, a width dimension of 0.5 mm to 4.5 mm, and a height dimension of 0.5 mm to 4.5 mm. The dimensions of the base body 10 are not limited to those specified herein. The term “rectangular parallelepiped” or “rectangular parallelepiped shape” used herein is not intended to mean solely “rectangular parallelepiped” in a mathematically strict sense. The dimensions and the shape of the base body 10 are not limited to those specified herein.

The base body 10 has a first principal surface 10a, a second principal surface 10b, a first end surface 10c, a second end surface 10d, a first side surface 10e, and a second side surface 10f. The outer surface of the base body 10 is defined by these six surfaces. The first principal surface 10a and the second principal surface 10b are at the opposite ends in the height direction of the base body 10, the first end surface 10c and the second end surface 10d are at the opposite ends in the length direction of the base body 10, and the first side surface 10e and the second side surface 10f are at the opposite ends in the width direction of the base body 10. As shown in FIG. 1, the first principal surface 10a is at the top of the base body 10, and therefore, the first principal surface 10a may be referred to as a “top surface.” Likewise, the second principal surface 10b may be referred to as a “lower surface” or “bottom surface.” Since the coil component 1 is disposed such that the second principal surface 10b faces the mounting substrate 2a, the second principal surface 10b may be herein referred to as “the mounting surface.” The top surface 10a and the bottom surface 10b are separated from each other by a distance equal to the height of the base body 10, the first end surface 10c and the second end surface 10d are separated from each other by a distance equal to the length of the base body 10, and the first side surface 10e and the second side surface 10f are separated from each other by a distance equal to the width of the base body 10.

As shown in FIG. 2, the base body 10 includes a plurality of metal magnetic layers that are stacked in the T-axis direction. These metal magnetic layers include metal magnetic layers 11-14, 15a-15d, 16a-16d, and 17a-17d.

On the upper surface of the metal magnetic layer 11, a conductor pattern 25a1 is formed. On the upper surface of the metal magnetic layer 12, a conductor pattern 25a2 is formed. The conductor patterns 25a1 and 25a2 extend around a coil axis Ax within a plane orthogonal to the coil axis Ax (the LW plane). The conductor pattern 25a1 has the same shape as the conductor pattern 25a2 when viewed from a coil axis direction that extends along the coil axis Ax. The conductor patterns 25a1 and 25a2 are arranged such that they overlap each other when viewed from the coil axis direction.

The metal magnetic layer 11 has a via conductor V1 formed therein at a predetermined position. The via conductor V1 is formed by forming a through hole at the predetermined position in the metal magnetic layer 11 such that it extends through the metal magnetic layer 11 in the T-axis direction, filling the through hole with a conductive paste, and firing the conductive paste. The conductor pattern 25a1 is electrically connected to the adjacent conductor patter 25a2 by means of the via conductor V1. The conductor patterns 25a1 and 25a2 are arranged electrically in parallel between the via conductor V1 and the external electrode 22. The conductor patterns 25a1 and 25a2, and the via conductor V1 form the first circling portion 25a. In other words, the first circling portion 25a is constituted by the conductor patterns 25a1 and 25a2, and the via conductor V1. As constituted by the conductor patterns 25a1 and 25a2 arranged in parallel, the first circling portion 25a has a lower DC resistance than when constituted by a single conductor pattern.

As clearly shown in FIG. 3, the metal magnetic layer 11 is interposed between the conductor patterns 25a1 and 25a2. The metal magnetic layer 11 is an example of “a first interposed layer” recited in the claims. The conductor pattern 25a1 is in contact with the top surface 11a of the metal magnetic layer 11. The conductor pattern 25a2 is in contact with the bottom surface 11b of the metal magnetic layer 11. The top surface 11a of the metal magnetic layer 11 faces the bottom surface 11b in the T-axis direction. The top surface 11a and the bottom surface 11b of the metal magnetic layer 11 intersect the coil axis Ax.

On the upper surface of the metal magnetic layer 13, a conductor pattern 25b1 is formed. On the upper surface of the metal magnetic layer 14, a conductor pattern 25b2 is formed. The conductor patterns 25b1 and 25b2 extend around the coil axis Ax within a plane orthogonal to the coil axis Ax. The conductor pattern 25b1 has the same shape as the conductor pattern 25b2 when viewed from the coil axis direction that extends along the coil axis Ax. The conductor patterns 25b1 and 25b2 overlap each other when viewed from the coil axis direction.

The metal magnetic layer 13 has a via conductor V2 formed therein at a predetermined position. The via conductor V2 is formed by forming a through hole at the predetermined position in the metal magnetic layer 13 such that it extends through the metal magnetic layer 13 in the T-axis direction, filling the through hole with a conductive paste, and firing the conductive paste. The conductor pattern 25b1 is electrically connected to the adjacent conductor pattern 25b2 by means of the via conductor V2. The conductor patterns 25b1 and 25b2 are arranged electrically in parallel between the via conductor V2 and the external electrode 21. The conductor patterns 25b1 and 25b2, and the via conductor V2 form the second circling portion 25b. In other words, the second circling portion 25b is constituted by the conductor patterns 25b1 and 25b2, and the via conductor V2. As constituted by the conductor patterns 25b1 and 25b2 arranged in parallel, the second circling portion 25b has a lower DC resistance than when constituted by a single conductor pattern.

As clearly shown in FIG. 3, the metal magnetic layer 13 is interposed between the conductor patterns 25b1 and 25b2. The metal magnetic layer 13 is an example of “a second interposed layer” recited in the claims. The conductor pattern 25b1 is in contact with the top surface 13a of the metal magnetic layer 13. The conductor pattern 25b2 is in contact with the bottom surface 13b of the metal magnetic layer 13. The top surface 13a of the metal magnetic layer 13 faces the bottom surface 13b in the T-axis direction. In addition, the top surface 13a of the metal magnetic layer 13 faces the bottom surface 11b of the metal magnetic layer 11. The top surface 13a and the bottom surface 13b of the metal magnetic layer 13 intersect the coil axis Ax.

The conductor patterns 25a1, 25a2, 25b1 and, 25b2 are composed mainly of a metal element M with excellent conductivity. The metal element M is, for example, Ag (silver), Cu (copper), Al (aluminum), or Ni (nickel) or their alloys. Note that the metal element M is a different element from the main component of metal magnetic particles 31, which will be described below. Therefore, when the main component of the metal magnetic particles 31 is Ni, a metal element other than Ni is employed as the metal element M. The conductive patterns 25a1, 25a2, 25b1 and 25b2 are formed by printing a conductive paste by screen printing. The conductive paste is produced by kneading and mixing a conductive powder formed mainly of the metal element M with a binder resin and a solvent. The conductor patterns 25a1, 25a2, 25b1 and 25b2 may be formed, for example, by sputtering, ink-jetting, or any other known methods. The phrase “the main component of the conductor pattern 25a1” refers to the metal component that makes up more than a half of the metal species by weight percent contained in the conductor pattern 25a1. The main components of the conductor patterns 25a2, 25b1, and 25b2 are defined similarly.

In the coil axis direction, an intermediate layer 15, which forms part of the base body 10, is located between the metal magnetic layers 11 and 13. The intermediate layer 15 is a laminate including a plurality of metal magnetic layers stacked together. In the illustrated embodiment, the intermediate layer 15 includes metal magnetic layers 15a to 15d.

The metal magnetic layer 12 had a via conductor V3 formed therein at a predetermined position, and so do the metal magnetic layers constituting the intermediate layer 15. The via conductor V3 is formed by forming a through hole at the predetermined position in the metal magnetic layer 12 or each of the metal magnetic layers constituting the intermediate layer 15 such that it extends through the metal magnetic layer in the T-axis direction, filling the through hole with a conductive paste, and thermally treating (firing) the conductive paste. The first and second circling portions 25a and 25b are electrically connected by means of the via conductors V3.

In the coil axis direction, an upper cover layer 16 is located above the metal magnetic layer 11, and a lower cover layer 17 is located below the metal magnetic layer 13. The upper and lower cover layers 16 and 17 can each have a plurality of metal magnetic layers. In the illustrated embodiment, the upper cover layer 16 includes metal magnetic layers 16a to 16d, and the lower cover layer 17 includes metal magnetic layers 17a to 17d.

The external electrode 21 is electrically connected to one end of the coil conductor 25, and the external electrode 22 is electrically connected to the other end of the coil conductor 25. The external electrodes 21 and 22 are formed by applying a conductive paste onto the surface of the base body 10 to form a base electrode, and subsequently forming a plating layer on the surface of the base electrode. The conductive paste for the external electrodes 21 and 22 may be produced by kneading and mixing a conductive powder formed mainly of the metal element M with a binder resin and a solvent, like the conductive paste for the conductor patterns 25a1, 25a2, 25b1 and 25b2. The plating layer may be constituted by, for example, two layers including a nickel plating layer containing nickel and a tin plating layer containing tin.

The following now describes the microstructure of the coil component 1 with reference to FIGS. 4 and 5. FIG. 4 is a schematic enlarged sectional view of a region A indicated in FIG. 3. The region A is a partial region of the section of the base body 10 along the T-axis. The region A may be any partial region of the section of the base body 10 along the T-axis. FIG. 5 is a schematic enlarged sectional view of a region B indicated in FIG. 3. The region B refers to the region extending from the conductor pattern 25a1 to the conductor pattern 25a2 in the section of the coil component 1 along the T axis. Since the metal magnetic layer 11 is interposed between the conductor patterns 25a1 and 25a2, the region B includes the metal magnetic layer 11.

As shown in FIG. 4, the base body 10 contains a large number of metal magnetic particles 31. The metal magnetic particles 31 each have an insulating film on their surface, and adjacent metal magnetic particles 31 are bonded to each other via the insulating films. The metal magnetic particles 31 are mainly composed of Fe or Ni. The metal magnetic particles 31 may contain, in addition to the main component element (Fe or Ni), at least one additive element selected from the group consisting of Cr, Al, Zr, Ti, Bi and Si. The metal magnetic particles 31 are constituted by, for example, Fe—Cr—Al, Fe—Si—Cr—Al, or a mixture of these materials. The metal magnetic particles contained in the base body 10 may be particles of (1) Fe or Ni, (2) alloys such as Fe—Si—Cr, Fe—Si—Al, or Fe—Ni, (3) amorphous materials such as Fe—Si—Cr—B—C or Fe—Si—B—Cr, or (4) a mixture of these materials. The material of the metal magnetic particles contained in the base body 10 is not limited to those described above. Here, adjacent metal magnetic particles 31 may be bonded to each other via a binder. The binder is, for example, a thermosetting resin.

The average particle size of the metal magnetic particles in the base body 10 is from 1 μm to 20μm. The average particle size of the metal magnetic particles contained in the base body 10 may be less than 1 μm or greater than 20 μm. The base body 10 may contain two or more types of metal magnetic particles having different average particle sizes. The “average particle size” of the metal magnetic particles 31 is determined in the following manner. The base body 10 is cut along the thickness direction (the T-axis direction) to expose a sectional surface. The sectional surface is photographed using a scanning electron microscope (SEM) to obtain an SEM image at 1000 to 5000-fold magnification, and the particle size distribution of the metal magnetic particles 31 is determined based on the SEM image. Based on the particle size distribution determined in the above manner, the average particle size can be calculated. For example, the 50th percentile (D50) of the particle size distribution obtained based on the SEM image can be used as the average particle size of the metal magnetic particles.

As shown in FIG. 5, the metal magnetic layer 11 contains a plurality of metal magnetic particles 31 and a plurality of segregates 41. The segregates 41 are composed mainly of the metal element M, which is also the main component of the conductor patterns 25a1, 25a2, 25b1 and 25b2. The segregates 41 are made from a non-magnetic material composed mainly of the metal element M. The segregates 41 are separated from both of the conductor patterns 25a1 and 25a2. This means that the segregates 41 are electrically connected to neither the conductor pattern 25a1 nor the conductor pattern 25a2. The phrase “the main component of the segregates 41” refers to the metal component that makes up more than a half of the metal species by weight percent contained in the segregates 41.

The segregates 41 can be distinguished from the metal magnetic particles 31 based on the difference in brightness between the segregates 41 and the metal magnetic particles 31 in an SEM image obtained by photographing the section of the coil component 1. The segregates 41 can be distinguished from the metal magnetic particles 31 also based on SEM-EDS mapping since the segregates 41 are composed mainly of the metal element M, which is different from the main component element of the metal magnetic particles 31.

In one aspect, the average particle size of the segregates 41 is less than 50% of a first conductor-to-conductor distance T1, which represents the distance in the coil axis direction between the conductor patterns 25a1 and 25a2. Since the average particle size of the segregates 41 is less than 50% of the first conductor-to-conductor distance T1 between the conductor patterns 25a1 and 25a2, the segregates 41 are more likely to be positioned away from both of the conductor patterns 25a1 and 25a2. In one aspect, the average particle size of the segregates 41 may be, for example, 0.5 to 5 μm. The average particle size of the segregates 41 may be less than that of the metal magnetic particles 31.

In one embodiment, in an electron microscope image obtained by photographing the metal magnetic layer 11 at a predetermined magnification in a section of the coil component 1 along a plane extending along the coil axis direction, the area occupied by the segregates is within the range of 0.5% to 50% of the total area occupied by the metal magnetic particles 31 in the metal magnetic layer 11 in the field of observation.

The metal magnetic layer 11 contains not only the metal magnetic particles 31 but also the segregates 41. Therefore, the filling factor of the metal magnetic particles 31 is lower in the metal magnetic layer 11 than in the other regions of the base body 10. For example, the filling factor of the metal magnetic particles 31 in the metal magnetic layer 11 is equal to or less than that in the intermediate layer 15. The filling factor of the metal magnetic particles 31 in the metal magnetic layer 11 is equal to or less than that in the upper cover layer 16. Also, the filling factor of the metal magnetic particles 31 in the metal magnetic layer 11 is equal to or less than that in the lower cover layer 17.

Although not shown, the metal magnetic layer 13 contains a plurality of segregates 41 like the metal magnetic layer 11. The description of the metal magnetic layer 11 also applies to the metal magnetic layer 13. For example, the filling factor of the metal magnetic particles 31 in the metal magnetic layer 13 is equal to or less than that in the other regions of the base body 10 (for example, the intermediate layer 15, the upper cover layer 16 and the lower cover layer 17).

In one aspect, except for the metal magnetic layers 11 and 13, the base body 10 does not contain the segregates 41. Since the segregates 41 are not included in the regions of the base body 10 other than the metal magnetic layers 11 and 13, the decrease in the magnetic permeability of the base body 10 can be suppressed even when the segregates 41 are composed of a non-magnetic material.

In another aspect, the segregates 41 may be included in other metal magnetic layers of the base body 10 than the metal magnetic layers 11 and 13. In this case, the density of the segregates 41 is lower in the metal magnetic layers other than the metal magnetic layers 11 and 13 than in the metal magnetic layers 11 and 13.

The first conductor-to-conductor distance T1 between the conductor patterns 25a1 and 25a2 is less than a second conductor-to-conductor distance T2, which represents the distance in the coil axis direction between the conductor patterns 25a2 and 25b1. The first conductor-to-conductor distance T1 between the first and second conductor patterns 25a1 and 25a2 falls within the range of approximately 1 μm to 10 μm, for example. The first conductor-to-conductor distance T1 is equal to the thickness dimension of the metal magnetic layer 11.

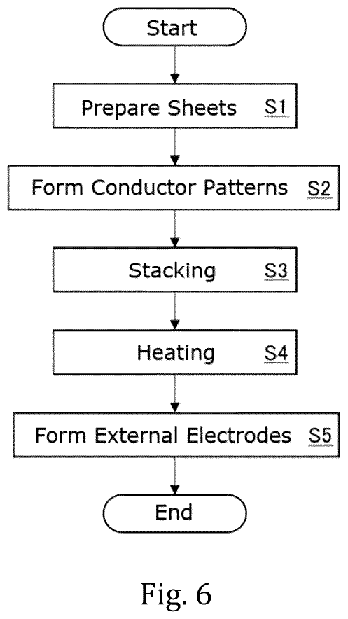

Next, one example of a manufacturing method of the coil component 1 will be described with reference to FIG. 6. FIG. 6 is a flowchart showing the manufacturing method of the coil component 1 according to one embodiment of the present disclosure. In the following, it is assumed that the coil component 1 is manufactured by the sheet lamination method. The coil component 1 may also be manufactured by any known methods other than the sheet lamination method. For example, the coil component 1 may be manufactured by a lamination method such as a printing lamination method, a thin-film process method, or a slurry build method.

In the first step S1, magnetic green sheets are fabricated. The magnetic green sheets are produced from a magnetic paste obtained by mixing and kneading a metal magnetic powder, which is the raw material of the metal magnetic particles 31, with a binder resin and a solvent. The metal magnetic powder is a fine powder made of a soft magnetic metal material composed mainly of Fe or Ni.

The binder resin for the magnetic paste may be acrylic resins, epoxy resins, polyimide resins, other known binder resins than those mentioned earlier, or mixtures thereof. One example of the solvent is toluene.

The magnetic paste is applied to the surface of a plastic base film by the doctor blade method or other common methods. The magnetic paste applied to the surface of the base film is dried to obtain sheet-shaped molded bodies. A molding pressure of approximately 10 MPa to 100 MPa is applied for molding to the sheet-shaped molded bodies in the mold, so that magnetic green sheets are fabricated.

In the step S1, two types of magnetic green sheets, i.e., first green sheets and second green sheets, are prepared. The first green sheets are the precursor of the metal magnetic layers 11 and 13. The second green sheets are the precursor of the other metal magnetic layers constituting the base body 10 than the metal magnetic layers 11 and 13 (e.g., the metal magnetic layers 12, 14, 15a-15d, 16a-16d and 17a-17d).

Hereinafter, a first magnetic paste refers to the magnetic paste used to produce the first green sheets, and a second magnetic paste refers to the magnetic paste used to produce the second green sheets. The first and second magnetic pastes differ in such a manner that the density of the metal magnetic powder is lower in the first magnetic paste than in the second magnetic paste. In other words, the first magnetic paste contains a greater amount of binder resin than the second magnetic paste for the same amount of metal magnetic powder. Since the first green sheets are made from the first magnetic paste, which contains the metal magnetic powder at a lower density than the second magnetic paste, the density of the metal magnetic powder is lower in the molded first green sheets than in the molded second green sheets.

In the next step S2, the conductive paste is applied to part of the magnetic green sheets prepared in the step S1, so that unfired conductor patterns, which are to be fired into the conductor patterns 25a1, 25a2, 25b1 and 25b2, are formed on the magnetic green sheets. The unfired conductor patterns that are the precursor of the conductor patterns 25a1 and 25b1 (first conductor patterns) are formed on the first green sheets, which contain the metal magnetic powder at a low density, and the unfired conductor patterns that are the precursor of the conductor patterns 25a2 and 25b2 (second conductor patterns) are formed on the second green sheets that contain the metal magnetic powder at a high density.

A through hole is formed in some of the magnetic green sheets such that it penetrates the magnetic green sheets in the stacking direction. For example, a through hole is formed in the magnetic green sheets that are the precursor of the metal magnetic layers 11-13 and 15a-15d. The through holes formed in these magnetic green sheets are filled with the conductive paste, when the conductive paste is applied to the first and second green sheets. In this way, unfired vias are formed in the through holes of the magnetic green sheets, and these unfired vias will be fired into the via conductors V1 to V3.

The conductive paste is produced by kneading and mixing the metal element M in the powdery form with a binder resin and a solvent. The binder resin for the conductive paste may be of the same type as the binder resin for the magnetic paste. Both the binder resin for the conductive paste and the binder resin for the magnetic paste may be acrylic resins. The conductive paste is applied to the magnetic green sheets by, for example, screen printing.

Next, in the step S3, the magnetic green sheets are stacked and then subject to thermo-compression bonding, so that a mother laminate is fabricated. Here, the first green sheet that has the unfired conductor pattern that is the precursor of the conductor pattern 25a1, is arranged on the second green sheet that has the unfired conductor pattern that is the precursor of the conductor pattern 25a2. Similarly, the first green sheet that has the unfired conductor pattern that is the precursor of the conductor pattern 25b1 is arranged on the second green sheet that has the unfired conductor pattern that is the precursor of the conductor pattern 25b2. Between the first green sheet that has the unfired conductor pattern that is the precursor of the conductor pattern 25b1 and the second green sheet that has the unfired conductor pattern that is the precursor of the conductor pattern 25a2, the magnetic green sheets that are the precursor of the metal magnetic layers 15a to 15d are sandwiched. Here, on the first green sheet that has the unfired conductor pattern that is the precursor of the conductor pattern 25a1, four magnetic green sheets that have no unfired conductor patterns (the precursor of the upper cover layer 16) are stacked. Furthermore, under the second green sheet that has the unfired conductor pattern that is the precursor of the conductor pattern 25b2, four magnetic green sheets that have no unfired conductor patterns (the precursor of the lower cover layer 17) are stacked.

Subsequently, the mother laminate is diced to a desired size by using a cutter such as a dicing machine or a laser processing machine to obtain a chip laminate.

Next, in the step S4, the chip laminate fabricated in the step S3 is heated. The heating can fire the unfired conductor patterns in the chip laminate into the conductor patterns 25a1, 25a2, 25b1, 25b2 and the via conductors V1 to V3. The heating also oxidizes the metal magnetic powder contained in the chip laminate into the metal magnetic particles 31, resulting in the base body 10 in which the metal magnetic particles 31 are bonded. In this way, the heating in the step S4 can provide a laminate having the coil conductor 25 provided in the base body 10.

The heating in the step S4 is performed at a heating temperature higher than the thermal decomposition start temperature of the binder resin and lower than the melting point of the metal element M. For example, if the binder resin is an epoxy resin and the metal element M is Ag, the heating can be performed at a heating temperature in the range of 600° C. to 850° C. The heating lasts for, for example, 30 minutes to 6 hours. The heating can thermally decompose the binder resin contained in the chip laminate. In other words, the chip laminate is degreased. The heating also oxidizes the surface of the metal magnetic powder in the chip laminate, so that the metal magnetic particles 31 are produced. The surface of the metal magnetic particles 31 is covered with an oxide film. The metal magnetic particles 31 are bonded to their adjacent ones via the oxide films.

The heating performed in the step S4 causes the metal element M contained in the unfired conductor patterns to thermally diffuse into the metal magnetic layers surrounding the unfired conductor patterns and to segregate between the metal magnetic particles 31 in the metal magnetic layers, so that the segregates 41 are produced. As mentioned above, the unfired conductor patterns are formed on the top surfaces of the magnetic green sheets that are the precursor of the metal magnetic layers 11 to 14. Of these magnetic green sheets, the first green sheets, which are the precursor of the metal magnetic layers 11 and 13, contain the metal magnetic powder at a lower density than the second green sheets, which are the precursor of the metal magnetic layers 12 and 14. Therefore, the metal element M is likely to thermally diffuse from the unfired conductor patterns toward the first green sheets. As a result of the thermal diffusion during the heating, the metal element M segregates in the first green sheets as the segregates 41. The metal element M may also thermally diffuse into the second green sheets, but the amount of the metal element M diffused into the second green sheets is less than that into the first green sheets. Therefore, in one aspect, the segregates 41 are not present in the metal magnetic layers 12 and 14, which are obtained by firing the second green sheets. In another aspect, a small amount of segregates 41 may be found in the metal magnetic layers 12 and 14. In this case, the density of the segregates 41 may be lower in the metal magnetic layers 12 and 14 than in the metal magnetic layers 11 and 13.

Next, in the step S5, the external electrodes 21 and 22 are formed on the surface of the base body 10 obtained in the step S4. The external electrodes 21 and 22 are formed by applying a conductive paste onto the surface of the base body 10 to form a base electrode, and subsequently forming a plating layer on the surface of the base electrode.

The coil component 1 is obtained through the above steps.

The coil component 1 according to an aspect of the present disclosure has the coil conductor 25 composed mainly of the metal element M, where the coil conductor 25 includes the conductor patterns 25a1 and 25a2 arranged in parallel. Between the conductor patterns 25a1 and 25a2, the metal magnetic layer 11 (first interposed layer) is interposed, where the metal magnetic layer 11 includes the metal magnetic particles 31 and the segregates 41. The segregates 41 are composed mainly of the metal element M, which is the main component of the coil conductor 25. As the metal magnetic layer 11 contains the segregates 41, which are composed mainly of the metal element M, the linear expansion coefficient of the metal magnetic layer 11 can be made closer to that of the conductor patterns 25a1 and 25a2 than when the metal magnetic layer 11 does not contain the segregates 41. This can lead to reducing the difference between the shrinkage rate of the metal magnetic layer 11 and that of the conductor patterns 25a1 and 25a2 even when the coil component 1 reaches high temperatures during use. Therefore, the present disclosure can reduce the stress applied by the conductor patterns 25a1 and 2512 to the metal magnetic layer 11. Accordingly, even when the coil component 1 reaches high temperatures, cracks can be suppressed in the metal magnetic layer 11, and the metal magnetic layer 11 can be prevented from peeling off from the conductor patterns 25a1 and 25a2. Due to the same mechanism, cracks can be also suppressed in the metal magnetic layer 13, and the metal magnetic layer 13 can be prevented from peeling off from the conductor patterns 25b1 and 25b2.

The Q characteristic of the coil component 1 is degraded if the magnetic flux induced by the current flowing through the conductor patterns 25a1 and 25a2, which are arranged in parallel, passes through the metal magnetic layer 11. According to an aspect of the present disclosure, the magnetic flux induced by the electric current flowing through the conductor patterns 25a1 and 25a2 is less likely to pass through the metal magnetic layer 11 because the segregates 41 in the metal magnetic layer 11 are composed of a non-magnetic material. This can reduce the deterioration of the Q characteristic of the coil component 1 that is caused by the conductor patterns 25a1 and 25a2, which are arranged in parallel with the metal magnetic layer 11 being interposed therebetween. Due to the same mechanism, the present disclosure can reduce the deterioration of the Q characteristic of the coil component 1 that is caused by the conductor patterns 25b1 and 25b2, which are arranged in parallel with the metal magnetic layer 13 being interposed therebetween.

One or more of the steps of the manufacturing method described herein can be omitted as appropriate. In the manufacturing method of the coil component 1, steps not described explicitly in this specification may be performed as necessary. A part of the steps included in the manufacturing method of the coil component 1 may be performed in different order within the purport of the present disclosure. A part of the steps included in the manufacturing method of the coil component 1 may be performed at the same time or in parallel, if possible.

The dimensions, materials, and arrangements of the constituent elements described for the above various embodiments are not limited to those explicitly described for the embodiments, and these constituent elements can be modified to have any dimensions, materials, and arrangements within the scope of the present disclosure.

Constituent elements not explicitly described herein can also be added to the above-described embodiments, and it is also possible to omit some of the constituent elements described for the embodiments.

The words “first,” “second,” “third” and so on used herein are added to distinguish constituent elements and do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A coil component (1) comprising:
a magnetic base body (10) containing a plurality of metal magnetic particles (31);
a coil conductor (25) provided in the magnetic base body so as to extend around a coil axis (Ax), the coil conductor being composed mainly of a metal element M;
a first external electrode (21) electrically connected to one end of the coil conductor; and
a second external electrode (22) electrically connected to another end of the coil conductor,
wherein the magnetic base body has a first interposed layer (11) containing a plurality of segregates (41) composed mainly of the metal element M, the first interposed layer having a first surface (11a) and a second surface (11b), the first surface intersecting the coil axis, the second surface facing the first surface in a coil axis direction that extends along the coil axis, and
wherein the coil conductor has:
   a first coil conductor pattern (25a1) touching the first surface of the first interposed layer;
   a second coil conductor pattern (25a2) touching the second surface of the first interposed layer, the second coil conductor pattern having a same shape as the first coil conductor pattern when viewed in the coil axis direction; and
   a first via conductor (V1) connecting the first and second coil conductor patterns.

### Additional Embodiment 2

The coil component of Additional Embodiment 1, wherein the segregates are made of a non-magnetic material composed mainly of the metal element M.

### Additional Embodiment 3

The coil component of Additional Embodiment 1 or 2, wherein the segregates are separated from both the first coil conductor pattern and the second coil conductor pattern.

### Additional Embodiment 4

The coil component of any one of Additional Embodiments 1 to 3, wherein, when viewed in the coil axis direction, the second coil conductor pattern overlaps the first coil conductor pattern.

### Additional Embodiment 5

The coil component of any one of Additional Embodiments 1 to 4, wherein an area occupied by the segregates is 0.5% or more of that occupied by the metal magnetic particles when a section of the first interposed layer along a plane extending along the coil axis direction is observed.

### Additional Embodiment 6

The coil component of any one of Additional Embodiments 1 to 5, wherein the first and second coil conductor patterns are arranged electrically in parallel.

### Additional Embodiment 7

The coil component of any one of Additional Embodiments 1 to 6, wherein, when a first particle size represents an average particle size of the segregates and a second particle size represents an average particle size of the metal magnetic particles, the first particle size is less than the second particle size.

### Additional Embodiment 8

The coil component of any one of Additional Embodiments 1 to 7, wherein, when a first particle size represents an average particle size of the segregates and a conductor-to-conductor distance (T1) represents a distance in the coil axis direction between the first and second coil conductor patterns, the first particle size is less than 50% of the conductor-to-conductor distance.

### Additional Embodiment 9

The coil component of any one of Additional Embodiments 1 to 8,
wherein the magnetic base body has a second interposed layer (13) containing a plurality of segregates (41) containing the metal element M, the second interposed layer having a third surface (13a) and a fourth surface (13b), the third surface facing the second surface of the first interposed layer in the coil axis direction, the fourth surface facing the third surface in the coil axis direction, and
wherein the coil conductor has:
   a third coil conductor pattern (25b1) touching the third surface of the second interposed layer;
   a fourth coil conductor pattern (25b2 ) touching the fourth surface of the second interposed layer, the fourth coil conductor pattern having a same shape as the third coil conductor pattern when viewed from the coil axis direction;
   a second via conductor (V2) connecting the third and fourth coil conductor patterns; and
   a third via conductor (V3) connecting the second and third coil conductor patterns.

### Additional Embodiment 10

The coil component of Additional Embodiment 9,
wherein the magnetic base body has an intermediate layer (15) disposed between the first and second interposed layers, and
wherein a first filling factor representing a filling factor of the metal magnetic particles in the first interposed layer and a second filling factor representing a filling factor of the metal magnetic particles in the second interposed layer are equal to or less than a third filling factor representing a filling factor of the metal magnetic particles in the intermediate layer.

### Additional Embodiment 11

The coil component of Additional Embodiment 10, wherein a first conductor-to-conductor distance (T1) representing a distance in the coil axis direction between the first and second coil conductor patterns is less than a second conductor-to-conductor distance (T2) representing a distance in the coil axis direction between the second and third coil conductor patterns.

### Additional Embodiment 12

The coil component of Additional Embodiment 10 or 11,
wherein the magnetic base body further has:
a first cover layer (16) provided on the first interposed layer; and
a second cover layer (17) provided under the second interposed layer, and
wherein the first and second filling factors are each equal to or less than a fourth filling factor representing a filling factor of the metal magnetic particles in the first cover layer and equal to or less than a fifth filling factor representing a filling factor of the metal magnetic particles in the second cover layer.

### Additional Embodiment 13

A method of manufacturing a coil component, comprising the steps of:
preparing a plurality of green sheets including a first green sheet containing a first metal magnetic powder at a first density and a second green sheet containing a second metal magnetic powder at a second density greater than the first density (S1);
forming a first conductor pattern containing a powder of a metal element M on the first green sheet (S2);
forming a second conductor pattern containing a powder of the metal element M on the second green sheet (S2);
stacking the green sheets such that the first green sheet is placed on the second green sheet, thereby making a laminate;
heating the laminate at a heating temperature lower than a melting point of the metal element M, thereby making a magnetic base body; and
providing an external electrode on the magnetic base body.

### Additional Embodiment 14

The method of claim 13,
wherein the metal element M is Ag, and
wherein the heating temperature falls within a range of 600° C. to 850° C.

What is claimed is:

1. A coil component comprising:
a magnetic base body containing a plurality of metal magnetic particles;
a coil conductor provided in the magnetic base body so as to extend around a coil axis, the coil conductor being composed mainly of a metal element M;
a first external electrode electrically connected to one end of the coil conductor; and
a second external electrode electrically connected to another end of the coil conductor,
wherein the magnetic base body has a first interposed layer containing a plurality of segregates composed mainly of the metal element M, the first interposed layer having a first surface and a second surface, the first surface intersecting the coil axis, the second surface facing the first surface in a coil axis direction that extends along the coil axis, and
wherein the coil conductor has:
a first coil conductor pattern touching the first surface of the first interposed layer;
a second coil conductor pattern touching the second surface of the first interposed layer, the second coil conductor pattern having a same shape as the first coil conductor pattern when viewed in the coil axis direction; and
a first via conductor connecting the first and second coil conductor patterns.

2. The coil component of claim 1, wherein the segregates are made of a non-magnetic material composed mainly of the metal element M.

3. The coil component of claim 1, wherein the segregates are separated from both the first coil conductor pattern and the second coil conductor pattern.

4. The coil component of claim 1, wherein, when viewed in the coil axis direction, the second coil conductor pattern overlaps the first coil conductor pattern.

5. The coil component of claim 1, wherein an area occupied by the segregates is 0.5% or more of that occupied by the metal magnetic particles when a section of the first interposed layer along a plane extending along the coil axis direction is observed.

6. The coil component of claim 1, wherein the first and second coil conductor patterns are arranged electrically in parallel.

7. The coil component of claim 1, wherein, when a first particle size represents an average particle size of the segregates and a second particle size represents an average particle size of the metal magnetic particles, the first particle size is less than the second particle size.

8. The coil component of claim 1, wherein, when a first particle size represents an average particle size of the segregates and a conductor-to-conductor distance represents a distance in the coil axis direction between the first and second coil conductor patterns, the first particle size is less than 50% of the conductor-to-conductor distance.

9. The coil component of claim 1,
wherein the magnetic base body has a second interposed layer containing a plurality of segregates containing the metal element M, the second interposed layer having a third surface and a fourth surface, the third surface facing the second surface of the first interposed layer in the coil axis direction, the fourth surface facing the third surface in the coil axis direction, and
wherein the coil conductor has:
a third coil conductor pattern touching the third surface of the second interposed layer;
a fourth coil conductor pattern touching the fourth surface of the second interposed layer, the fourth coil conductor pattern having a same shape as the third coil conductor pattern when viewed from the coil axis direction;
a second via conductor connecting the third and fourth coil conductor patterns; and
a third via conductor connecting the second and third coil conductor patterns.

10. The coil component of claim 9,
wherein the magnetic base body has an intermediate layer disposed between the first and second interposed layers, and
wherein a first filling factor representing a filling factor of the metal magnetic particles in the first interposed layer and a second filling factor representing a filling factor of the metal magnetic particles in the second interposed layer are equal to or less than a third filling factor representing a filling factor of the metal magnetic particles in the intermediate layer.

11. The coil component of claim 10,
wherein a first conductor-to-conductor distance representing a distance in the coil axis direction between the first and second coil conductor patterns is less than a second conductor-to-conductor distance representing a distance in the coil axis direction between the second and third coil conductor patterns.

12. The coil component of claim 10,
wherein the magnetic base body further has:
a first cover layer provided on the first interposed layer; and
a second cover layer provided under the second interposed layer, and
wherein the first and second filling factors are equal to or less than a fourth filling factor representing a filling factor of the metal magnetic particles in the first cover layer and a fifth filling factor representing a filling factor of the metal magnetic particles in the second cover layer.

13. A method of manufacturing a coil component, comprising the steps of:
preparing a plurality of green sheets including a first green sheet containing a first metal magnetic powder at a first density and a second green sheet containing a second metal magnetic powder at a second density greater than the first density;
forming a first conductor pattern containing a powder of a metal element M on the first green sheet;
forming a second conductor pattern containing a powder of the metal element M on the second green sheet;
stacking the green sheets such that the first green sheet is placed on the second green sheet, thereby making a laminate;
heating the laminate at a heating temperature lower than a melting point of the metal element M, thereby making a magnetic base body; and
providing an external electrode on the magnetic base body.

14. The method of claim 13,
wherein the metal element M is Ag, and
wherein the heating temperature falls within a range of 600° C. to 850° C.
